(19) United States
(12) Patent Application Publication
(10) Pub. No.: US 2007/0194699 A1
(43) Pub. Date: Aug. 23, 2007

(54) DISPLAY APPARATUS AND METHOD OF MANUFACTURING THE SAME

(75) Inventors: Sang-pil LEE, Seoul (KR); Seung-kyu PARK, Hwaseong-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD., Suwon-si (KR)

(21) Appl. No.: 11/676,776

(22) Filed: Feb. 20, 2007

(30) Foreign Application Priority Data
Feb. 20, 2006 (KR) 10-2006-0016203

(51) Int. Cl. H01J 1/62; H01J 63/04

(52) U.S. Cl. 313/505; 313/483; 313/498

(57) ABSTRACT

A display apparatus includes; an insulating substrate, a first signal line formed on the insulating substrate, a second signal line crossing the first signal line, an auxiliary electrode line which is supplied with a common voltage and disposed on the insulating substrate, a first plurality of thin film transistors formed on the insulating substrate electrically connected with the first signal line and the second signal line, a second plurality of thin film transistors electrically connected with the first plurality of thin film transistors, pixel electrodes connected to one of the plurality of thin film transistors, each pixel electrode comprising a reflective layer, a conductive bridge portion connected to the auxiliary electrode line through a first contact hole, partitions including second contact holes which expose the bridge and surround the pixel electrodes, a light emitting device layer including a light emitting layer formed in a first region on the pixel electrodes, and a common layer exposing the first and the second contact holes formed over the first region and a second region surrounding the first region, and a common electrode formed on the light emitting device layer and electrically connected to the bridge through the second contact holes.

This application claims priority to Korean Patent Application No. 2006-0016203, filed on Feb. 20, 2006, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus and a method of manufacturing the same, and more particularly, to a display apparatus with an auxiliary electrode line and a common electrode connected to each other, and a method of manufacturing the same.

2. Description of the Related Art

Organic light emitting diode (“OLED”) displays have recently gained popularity among the various flat panel displays because of their advantageous characteristics including low voltage driving, lightness, thinness, wide viewing angle, high speed response and various other characteristics.

An OLED display may be divided into a bottom emission type and a top emission type depending on the direction of emission of light generated in a light emitting layer.

In the top emission type, the light generated in the light emitting layer is emitted to the outside through a common electrode. Accordingly, this type of display may have a high aperture ratio without any aperture ratio reduction due to thin film transistors, which are generally located below the light emitting layer with respect to the common electrode. The top emission type of display requires a transparent common electrode, which typically has a high electrical resistance, thereby making application of a common voltage thereto difficult.

To avoid this difficulty in the top emission type display, an auxiliary electrode line through which the common voltage is applied to the common electrode is formed in a display region. The auxiliary electrode more evenly distributes the common voltage to the display area than a common electrode alone. In order to connect the common electrode to the auxiliary electrode line, the auxiliary electrode line has to be exposed on the common electrode forming layer before the common electrode is formed. However, forming this exposed structure complicates a manufacturing process of the OLED display.

### BRIEF SUMMARY OF THE INVENTION

Accordingly, it is an aspect of the present invention to provide a display apparatus with an auxiliary electrode line and a common electrode connected to each other and with a simple manufacturing process.

It is another aspect of the present invention to provide a manufacturing method of a display apparatus with an auxiliary electrode line and a common electrode connected to each other and with a simple manufacturing process.

An exemplary embodiment of a display apparatus includes; an insulating substrate, a first signal line formed on the insulating substrate, a second signal line crossing the first signal line, an auxiliary electrode line which is supplied with a common voltage disposed on the insulating substrate, a first plurality of thin film transistors formed on the insulating substrate electrically connected with the first signal line and the second signal line, a second plurality of thin film transistors electrically connected with the first plurality of thin film transistors, pixel electrodes connected to one of the plural thin film transistors, each pixel electrode including a reflective layer, a conductive bridge portion connected to the auxiliary electrode line through a first contact hole, partitions including second contact holes which expose the bridge and surround the pixel electrodes, a light emitting device layer including a light emitting layer formed in a first region on the pixel electrodes, and a common layer exposing the first and the second contact holes formed on the first region and a second region surrounding the first region, and a common electrode formed on the light emitting device layer and electrically connected to the bridge through the second contact holes.

According to one exemplary embodiment, the common layer is formed in substantially one part throughout the display device.

According to one exemplary embodiment, the light emitting layer is made of a high molecular weight material, and the common layer includes an electron injection layer formed on the light emitting layer.

According to one exemplary embodiment, the light emitting layer is made of a low molecular weight material, and the common layer includes a first sub-common layer disposed below the light emitting layer and a second sub-common layer disposed above the light emitting layer.

According to one exemplary embodiment, the pixel electrodes and the conductive bridge portion are disposed substantially the same distance from the insulating substrate.

An exemplary embodiment of a display apparatus having a display region and a non-display region, includes; an insulating substrate, a first signal line formed on the insulating substrate, a second signal line crossing the first signal line, an auxiliary electrode line which is supplied with a common voltage disposed on the insulating substrate, a first plurality of thin film transistors formed on the insulating substrate electrically connected with the first signal line and the second signal line, a second plurality of thin film transistors electrically connected to the first plurality of thin film transistors, pixel electrodes connected to one of the first plurality of thin file transistors, partitions which include contact holes and surround the pixel electrodes, a light emitting device layer formed in substantially one piece on the pixel electrodes and the partitions in the display region, including non-formation holes corresponding to the contact holes, and a common electrode formed on the light emitting device layer and connected to the auxiliary electrode line through the non formation and contact holes.

In one exemplary embodiment the light emitting device layer includes; a light emitting layer formed in a first region corresponding to the pixel electrodes, and a common layer formed on the first region and a second region surrounding the first region.

In one exemplary embodiment, the contact holes are formed in a region separated from the first region.

In one exemplary embodiment, each of the pixel electrodes includes a reflective layer and the common electrode is substantially transparent.

An exemplary embodiment of a method of manufacturing a display apparatus, including; forming a first plurality of thin film transistors electrically connected with a first signal line and a second signal line on an insulating substrate, forming an auxiliary electrode line on the insulating, forming a bridge portion which contacts the auxiliary electrode line, connecting pixel electrodes to one of the plurality of thin film transistors through the first contact holes, forming partitions surrounding the pixel electrodes and including second contact holes which expose the bridge portion, forming a light emitting device layer including a light emitting layer and a common layer on the pixel electrodes and the partitions, removing the light emitting device layer from the second contact holes, and forming a common electrode on the light emitting device wherein the common electrode is connected to the bridge through the second contact holes.

In one exemplary embodiment, the removing the light emitting device layer includes using a first shadow mask having openings formed corresponding to the second contact holes.

In one exemplary embodiment, the removing the light emitting device layer includes using at least one of oxygen and argon produced from a plasma gas.

In one exemplary embodiment, the common layer is formed using an open mask.

In one exemplary embodiment, the common layer is removed when the light emitting device layer is removed, and the common layer includes at least one of a hole injection layer, a hole transfer layer, an electron transfer layer, and an electron injection layer.

In one exemplary embodiment, each of the pixel electrodes includes a reflective layer.

An exemplary embodiment of a method of manufacturing a display apparatus, includes; forming an auxiliary electrode line to be applied with a common voltage on an insulating substrate, forming partitions which include contact holes which facilitate an electrical connection between the auxiliary electrode line and a pixel electrode, forming a light emitting device layer on the partitions, removing the light emitting device layer formed on the contact holes, and forming the common electrode on the light emitting device layer, wherein the common electrode is connected to the auxiliary electrode line through the contact holes.

In one exemplary embodiment, the removing the light emitting device layer includes using a shadow mask having openings formed corresponding to the contact holes.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is an equivalent circuit diagram of an exemplary embodiment of a pixel in a first exemplary embodiment of a display apparatus according to the present invention;

FIG. 2 shows a top plan layout view of the first exemplary embodiment of a display apparatus according to the present invention;

FIG. 3 is a cross-sectional view taken along line III-III of FIG. 2;

FIG. 4 is a top plan schematic view showing an exemplary arrangement of a common layer and a common electrode in the first exemplary embodiment of a display apparatus according to the present invention;

FIG. 5 is a top plan schematic view showing an exemplary arrangement of a transparent conductive layer and a light emitting layer in the first exemplary embodiment of a display apparatus according to the present invention;

FIG. 6 is a diagram explaining the principle of light emission of the first exemplary embodiment of a display apparatus according to the present invention;

FIG. 7 is a side schematic view of the first exemplary embodiment of a display apparatus including an encapsulating layer according to the present invention;

FIG. 8A is a cross-sectional view illustrating a step in an exemplary embodiment of a method of manufacturing the first exemplary embodiment of a display apparatus according to the present invention;

FIG. 8B is a top plan schematic view illustrating a step in an exemplary embodiment of a method of manufacturing the first exemplary embodiment of a display apparatus according to the present invention;

FIG. 9A is a cross-sectional view illustrating a step in an exemplary embodiment of a method of manufacturing the first exemplary embodiment of a display apparatus according to the present invention;

FIG. 9B is a side schematic view illustrating a step in an exemplary embodiment of a method of manufacturing the first exemplary embodiment of a display apparatus according to the present invention;

FIG. 9C is a front perspective view illustrating a step in an exemplary embodiment of a method of manufacturing the first exemplary embodiment of a display apparatus according to the present invention;

FIG. 10A is a cross-sectional view illustrating a step in an exemplary embodiment of a method of manufacturing the first exemplary embodiment of a display apparatus according to the present invention;

FIG. 10B is a side schematic view illustrating a step in an exemplary embodiment of a method of manufacturing the first exemplary embodiment of a display apparatus according to the present invention;

FIG. 10C is a top plan schematic view illustrating a step in an exemplary embodiment of a method of manufacturing the first exemplary embodiment of a display apparatus according to the present invention;

FIG. 10D is a top plan schematic view illustrating a step in an exemplary embodiment of a method of manufacturing the first exemplary embodiment of a display apparatus according to the present invention;

FIG. 11A is a cross-sectional view illustrating a step in an exemplary embodiment of a method of manufacturing the first exemplary embodiment of a display apparatus according to the present invention;

FIG. 11B is a side schematic view illustrating a step in an exemplary embodiment of a method of manufacturing the first exemplary embodiment of a display apparatus according to the present invention;

FIG. 12A is a cross-sectional view illustrating a step in an exemplary embodiment of a method of manufacturing the first exemplary embodiment of a display apparatus according to the present invention;

FIG. 12B is a top plan schematic view illustrating a step in an exemplary embodiment of a method of manufacturing the first exemplary embodiment of a display apparatus according to the present invention;

FIG. 13 is a side schematic view illustrating a step in an exemplary embodiment of a method of manufacturing the first exemplary embodiment of a display apparatus according to the present invention;

FIGS. 14 and 15 are top plan schematic views showing different forms of an exemplary embodiment of a shadow mask used for an ashing process in the exemplary embodiment of a method of manufacturing the first exemplary embodiment of a display apparatus according to the present invention;

FIG. 16 is a cross-sectional view of a second exemplary embodiment of a display apparatus according to the present invention; and

FIG. 17 is a cross-sectional view of a third exemplary embodiment of a display apparatus according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in more detail with reference to the accompanying drawings.

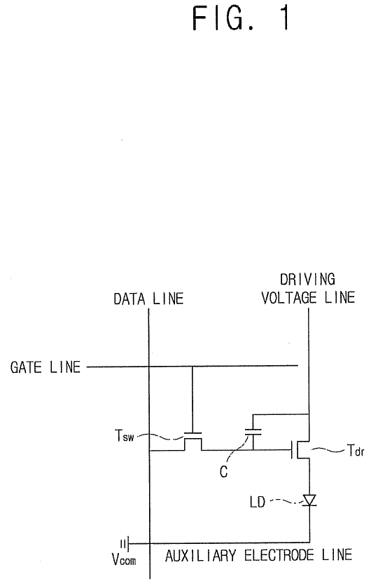

FIG. 1 is an equivalent circuit diagram of an exemplary embodiment of a pixel in a first exemplary embodiment of a display apparatus according to the present invention;

Referring to FIG. 1, a plurality of signal lines are provided in one pixel. The signal lines include a gate line for transmitting a scan signal, a data line for transmitting a data signal, and a driving voltage line for transmitting a driving voltage. The data line and the driving voltage are adjacent, and substantially parallel to, each other, and the gate line extends substantially perpendicular to the data line and the driving voltage line. The exemplary embodiment of a display device includes a plurality of pixels.

Each pixel includes an organic light emitting device LD, a switching thin film transistor (“TFT”) Tsw, a driving TFT Tdr and a capacitor C.

The driving TFT Tdr has a control terminal connected to the switching TFT Tsw, an input terminal connected to the driving voltage line, and an output terminal connected to the organic light emitting device LD.

The organic light emitting element LD has an anode connected to the output terminal of the driving TFT Tdr and a cathode connected to an auxiliary electrode line Vcom. To display an image, the organic light emitting device LD in each of the plurality of pixels emits light with a brightness which varies depending on the amount of output current of the driving TFT Tdr. The intensity of the output current of the driving TFT Tdr varies depending on a difference in a voltage level applied between the control terminal and the output terminal thereof.

The switching TFT Tsw has a control terminal connected to the gate line, an input terminal connected to the data line, and an output terminal connected to the control terminal of the driving transistor Tdr. The switching TFT Tsw transmits the data signal applied to the data line to the driving TFT Tdr according to the scan signal applied to the gate line.

The capacitor C is connected between the control terminal and the input terminal of the driving TFT Tdr. The data signal charges the capacitor C after passing through the switching TFT Tsw and the capacitor holds the charged signal to input to the control terminal of the driving TFT Tdr.

In the pixel of the first exemplary embodiment of a display apparatus 1 as described above, the cathode of the organic light emitting device LD is directly applied with a common voltage through the auxiliary electrode line. Accordingly, the cathode is uniformly supplied with the common voltage irrespective of the pixel's position in the display device.

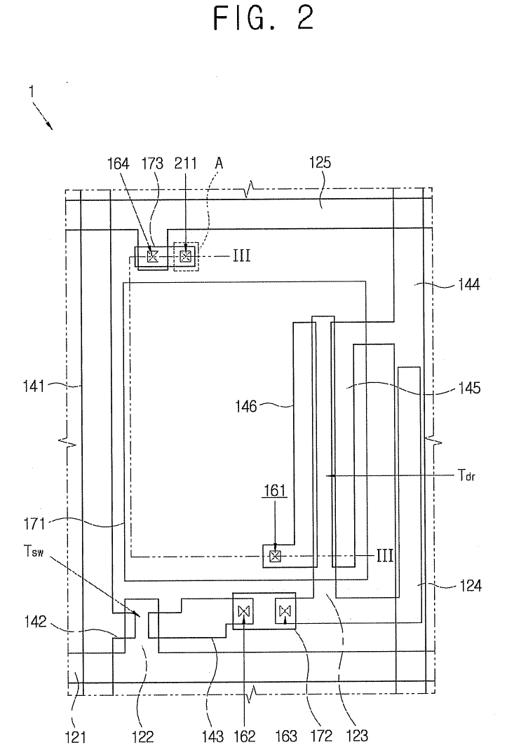

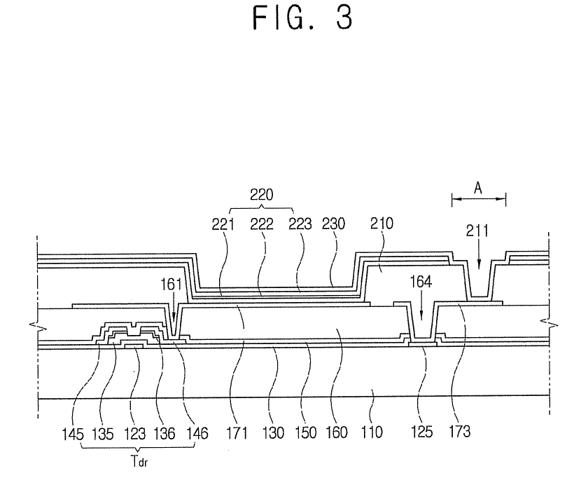

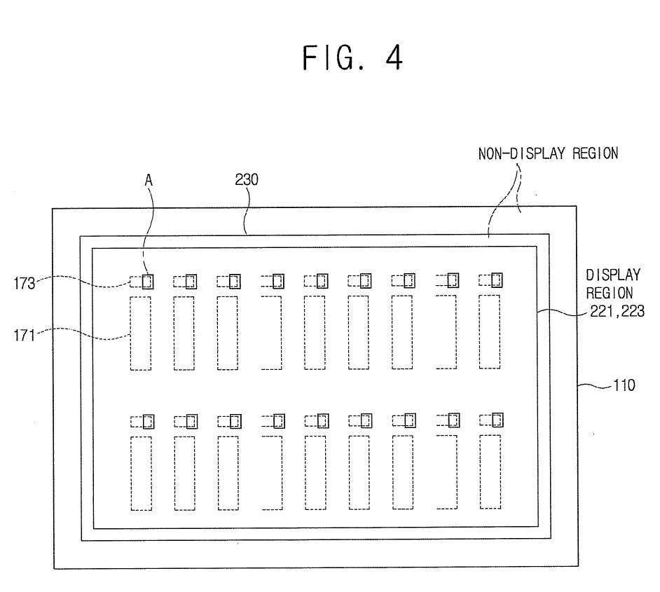

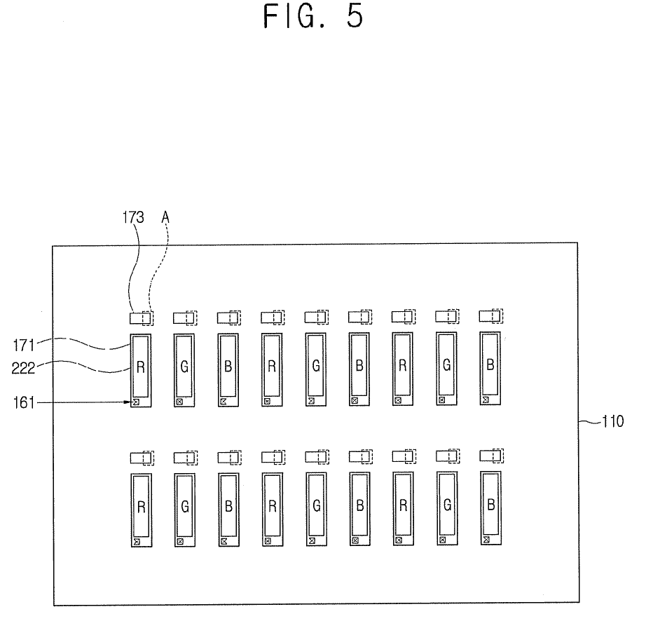

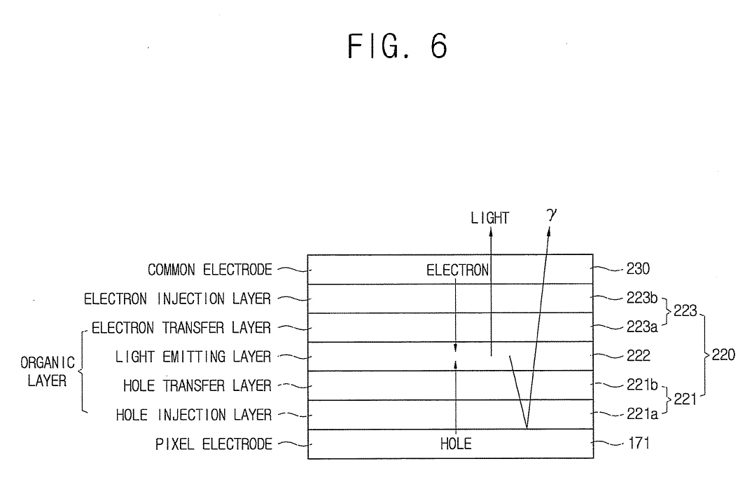

Hereinafter, the first exemplary embodiment of a display apparatus 1 according to the present invention will be described in more detail with reference to FIGS. 2 to 6. FIG. 2 shows a top plan layout view of the first exemplary embodiment of a display apparatus 1 according to the present invention, FIG. 3 is a cross-sectional view taken along line III-III of FIG. 2, FIG. 4 is a top plan schematic view showing an exemplary arrangement of a common layer and a common electrode in the first exemplary embodiment of a display apparatus 1 according to the present invention, FIG. 5 is a top plan schematic view showing an exemplary arrangement of a transparent conductive layer and a light emitting layer in the first exemplary embodiment of a display apparatus 1 according to the present invention, and FIG. 6 is a diagram explaining the principle of light emission of the first exemplary embodiment of a display apparatus according to the present invention.

Although the switching TFT Tsw is not shown in FIG. 3, it is similar to the driving TFT Tdr.

Referring to FIGS. 2 and 3, gate wiring lines, including elements 121 to 125, are formed on the insulating substrate 110.

The gate wiring lines include a plurality of gate lines 121 arranged substantially in parallel with each other at regular intervals, a switching gate electrode 122 comprising one part of the switching TFT Tsw, a driving gate electrode 123 comprising one part of the driving TFT Tdr, a capacitance forming portion 124 forming part of a capacitor extending below a driving voltage line 144, and an auxiliary electrode line 125 for applying a common voltage to a common electrode 230. In the present exemplary embodiment, the gate lines 121 and the switching gate electrode 122 are integrally formed, and the driving gate electrode 123 and the capacitance forming part are also integrally formed.

A gate insulating layer 130 is formed on the gate wiring lines 121 to 125. In one exemplary embodiment the gate insulating layer 130 is made of inorganic material such as silicon nitride or other similar materials.

A semiconductor layer 135 is formed on the gate insulating layer 130 above the driving gate electrode 123.

In one exemplary embodiment the semiconductor layer 135 is made of amorphous silicon, micro-crystalline silicon, or crystalline silicon. An ohmic contact layer 136 is formed on the semiconductor layer 135. The ohmic contact layer is separated into two portions with respect to the driving gate electrode 123. In one exemplary embodiment the ohmic contact layer 136 is formed primarily of n+ silicon or other similar substances.

Data wiring lines, including elements 141 to 146, are formed on the ohmic contact layer 136 and the gate insulating layer 130.

The data wiring lines 141 to 146 include a plurality of data lines 141 arranged substantially in parallel to each other and substantially perpendicular to the gate lines 121, a switching source electrode 142 and a switching drain electrode 143, both of which comprise a portion of the switching TFT Tsw, a driving voltage line 144 for applying a driving voltage, and a driving source electrode 145 and a driving drain electrode 146, both of which comprise a portion of the driving TFT Tdr. In the present exemplary embodiment the data lines 141 and the switching source electrode 142 are integrally formed, and the driving voltage line 144 and the driving source electrode 145 are also integrally formed.

A passivation layer 150 is formed on the data wiring lines 141 to 146 and also on a portion of the semiconductor layer 135, which is not covered with the data wiring lines 141 to 146. In one exemplary embodiment the passivation layer 150 may be made of silicon nitride.

A planarizing layer 160 made of organic material is formed on the passivation layer 150. Contact holes 161, 162, 163 and 164 are formed on the driving drain electrode 146, the switching drain electrode 143, the driving gate electrode 123 and the auxiliary electrode line 125, respectively. In one exemplary embodiment the planarizing layer 160 may be made of any material in the bensocyclobutene (“BCB”) series, olefin series, acryl resin series, polyimide series and Teflon™ series, in addition it may be made of one of Cytop™ and perfluorocyclobutane.

Reflective conductive layers, including elements 171 to 173, are formed on the planarizing layer 160. The reflective conductive layers 171 to 173 include a pixel electrode 171 and first and second bridge portions 172 and 173. The pixel electrode 171 is electrically connected to the driving drain electrode 146 via the contact hole 161. The pixel electrode 171 supplies holes to a light emitting layer 222 of the organic light emitting diode (“OLED”). The first bridge portion 172 is connected to the switching drain electrode 143 and the driving gate electrode 123 via the contact holes 162 and 163. The second bridge portion 173 has one end connected to the auxiliary electrode line 125 and the other end connected to the common electrode 230 via a partition contact hole 211, which will be described in more detail below. In this manner, the auxiliary electrode line 125 and the common electrode 230 are connected to each other via the second bridge portion 173.

In one exemplary embodiment the reflective conductive layers 171 to 173 include a reflective layer made of metal, exemplary embodiments of which include chrome, nickel, molybdenum, aluminum and silver. In another exemplary embodiment the reflective conductive layers 171 to 173 may be constructed with three or two layers, e.g., a reflective conductive layer having a transparent conductive layer/reflective layer/transparent conductive layer structure, or a transparent conductive layer/reflective layer structure, or a reflective layer/transparent conductive layer structure. In one exemplary embodiment the transparent conductive layer may be made of indium tin oxide (“ITO”) or indium zinc oxide (“IZO”). Light may be emitted from the light emitting layer 222 in a variety of directions, however, light traveling in toward the pixel electrode 171 is reflected toward the common electrode 230 by the reflectivity of the pixel electrode 171.

A partition 210 is formed between one pixel electrode 171 and an adjacent pixel electrode 171. The partition 210 defines a pixel region by dividing pixel electrodes 171. In one exemplary embodiment the partition 210 may be made of photosensitive materials having heat resistance and solvent resistance, such as acryl resin or polyimide resin, or inorganic materials such as silicon dioxide (“SiO₂”) or titanium dioxide (“TiO₂”), and may have a two-layered structure of including an organic layer and an inorganic layer. The partition contact hole 211 is formed in the partition 210 and exposes the second bridge portion 173.

A light emitting device layer 220 is formed on the pixel electrode 171 and the partition 210. The light emitting device layer 220 includes a lower common layer 221, the light emitting layer 222 and an upper common layer 223.

In this exemplary embodiment, the common layers 221 and 223 refer to a layer having substantially the same composition in all pixels. In one exemplary embodiment wherein the light emitting layer 222 comprises a plurality of sub layers emitting light with different colors, the light emitting layer 222 is not a common layer. In an alternative exemplary embodiment, if the light emitting layer 222 emits only white light, it can be a common layer. In such an exemplary embodiment, a color filter may be formed on the common electrode 230.

In the first exemplary embodiment, the light emitting device layer 220 is formed by thermal evaporation and is made of a low molecular weight organic material, except for an electron injection layer 223b which is not made of a low molecular weight organic material (the structure of the light emitting device layer 200 will be described in more detail with reference to FIG. 6).

A region in which the reflective conductive layers 171 to 173 and the light emitting device layer 220 are formed will be described below with reference to FIGS. 4 and 5. First bridge portions 172 are not shown in FIGS. 4 and 5.

As shown in FIG. 4, the common layers 221 and 223 are formed on a display region in which an image is displayed. The common layers 221 and 223 are formed substantially continuously over the entire display region and have non-formation areas A, wherein the common layers 221 and 223 are not formed. The non-formation areas A correspond to the partition contact holes 211. The non-formation areas A are arranged substantially in the form of a matrix.

As shown in FIG. 5, light emitting layers 222 are alternatingly and discretely formed on the pixel electrodes 171 according to color of light emitted thereby. All of the pixel electrodes 171 and the light emitting layer 222 are isolated from the partition contact holes 211 or the non-formation areas A. The pixel electrodes 171 and the second bridge portions 173 are discretely arranged in a substantially matrix form, respectively.

In an alternative exemplary embodiment, the light emitting layer 222 may be formed wider than the pixel electrodes 171 or may be formed to partially not to overlap the pixel electrodes 171. In this case, some of the light emitting layer 222 may be extended over the partition 210.

Referring again to FIG. 3, the common electrode 230 is formed on the light emitting device layer 220. As shown in FIG. 4, the common electrode 230 is formed over a range wider than the display region. The common electrode 230, which in one exemplary embodiment is substantially transparent, may be constructed with a two-layered structure, exemplary embodiments of which include a magnesium-silver alloy layer and a transparent conductive layer or a calcium-silver alloy layer and a transparent conductive layer. The thickness of the magnesium-silver alloy layer or the calcium-silver alloy layer may be between about 50 nm and about 200 nm. If the thickness of the common electrode is less than about 50 nm, its resistance increases excessively, making application of a common voltage thereto difficult. If the thickness of the common electrode exceeds 200 nm, the common electrode 230 will become at least partially opaque.

In one exemplary embodiment the transparent conductive layer is formed by a sputtering process. In such an exemplary embodiment temperature in the sputtering process is limited to protect the light emitting layer 220 disposed below the transparent conductive layer.

As shown in FIG. 6, the lower common layer 221 is formed on the pixel electrode 171 and the partition 210 and includes a hole injection layer 221a and a hole transfer layer 221b. Exemplary embodiments of the hole injection layer 221a and the hole transfer layer 221b may be made of amine derivatives with strong fluorescence such as triphenyl diamine derivatives, styrylamine derivatives, and amine derivatives with aromatic condensation rings.

The light emitting layer 222 is formed on the lower common layer 221.

The upper common layer 223 is formed on the light emitting layer 222 and the lower common layer 221. The upper common layer 223 includes an electron transfer layer 223a and the electron injection layer 223b. Exemplary embodiments of the electron transfer layer 223a may be made of quinoline derivatives, particularly, aluminum tris(8-hydroxyquinoline) (Alq3), or phenyl anthracene derivatives or tetraarylethene derivatives. Exemplary embodiments of the electron injection layer 223b may be made of at least one of barium (Ba) and calcium (Ca).

Holes transferred from the pixel electrode 171 and electrons transferred from the common electrode 230 are combined together into excitons in the light emitting layer 222. Excitons generate light in the course of their de-excitation. The de-excitation generates photons (light) in an omni-directional manner. The light directed to the pixel electrode 171 is reflected toward the common electrode 230 as illustrated by the arrow ending in an y in FIG. 6. Since the common electrode 230 is substantially transparent, the light from the light emitting layer 222 is emitted to the outside via the common electrode 230.

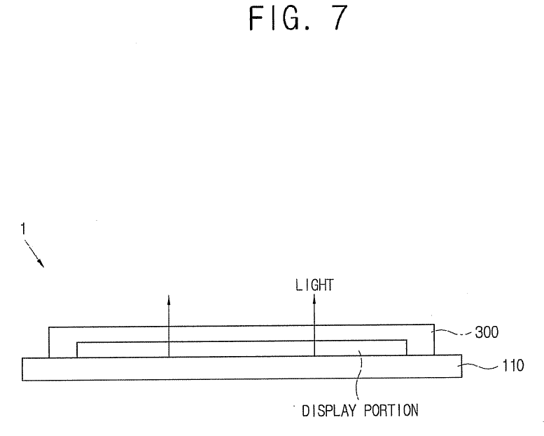

FIG. 7 is a side schematic view of the first exemplary embodiment of a display apparatus 1 including an encapsulating layer according to the present invention. The encapsulating layer protects the light emitting device layer 220 against oxygen and moisture.

An encapsulating layer 300 covers a display portion formed on the insulating substrate 110. The display portion includes the driving TFT Tdr, the light emitting layer 220 and the common electrode 23 as shown in FIG. 3.

In one exemplary embodiment the encapsulating layer 300 may be formed by coating an inorganic material or an inorganic insulating material on the display portion using a sputtering method or a chemical vapor deposition method. In the exemplary embodiment wherein the encapsulating layer 300 is made of resin, it may be formed using a screen printing method.

Although not shown, in one exemplary embodiment the display apparatus 1 may further include an encapsulation substrate in addition to the encapsulating layer 300.

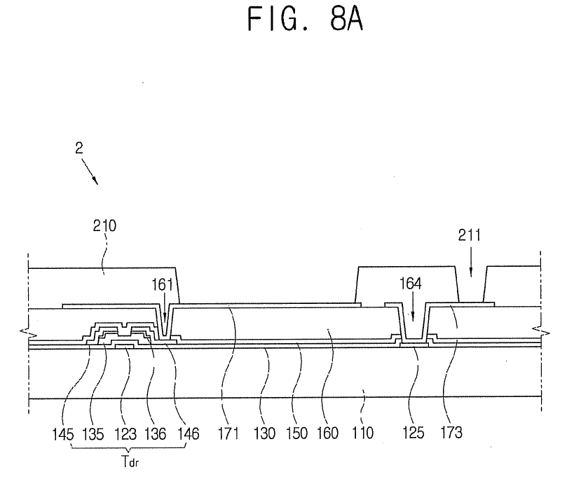

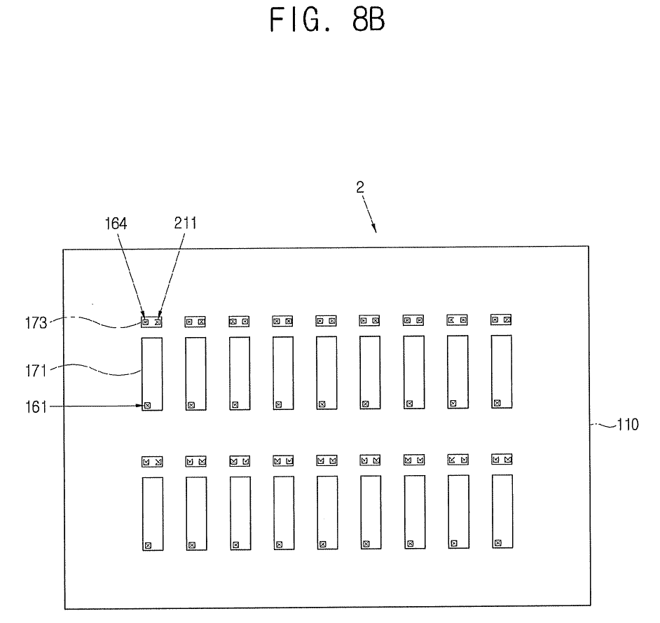

Now, an exemplary embodiment of a manufacturing method of the first exemplary embodiment of a display apparatus according to the present invention will be described with reference to FIGS. 8a to 13.

First, as shown in FIGS. 8A and 8B, a deposition-object substrate 2 on which the partition 210 is formed is prepared. The deposition-object substrate 2 may be formed using any of several well known methods, and therefore, explanation of a manufacturing process of which will be omitted for the sake of brevity.

FIG. 8B shows the pixel electrode formation region 171 and the second bridge portion 173 of the reflective conductive layers 171, 172 and 173. The pixel electrode 171 contacts the driving drain electrode 146 via the contact hole 161. The second bridge portion 173 is connected to the auxiliary electrode line 125 via the contact hole 164 and is partially exposed through the partition contact hole 211.

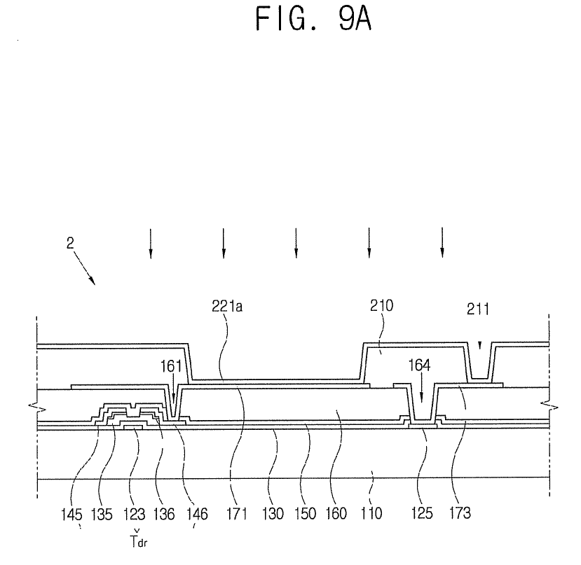

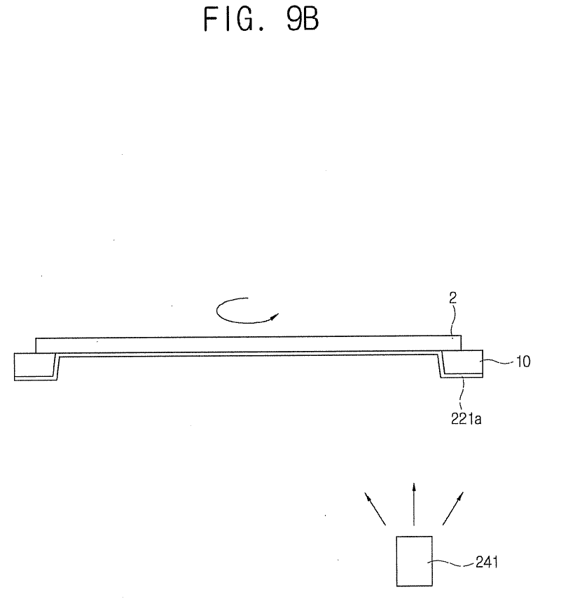

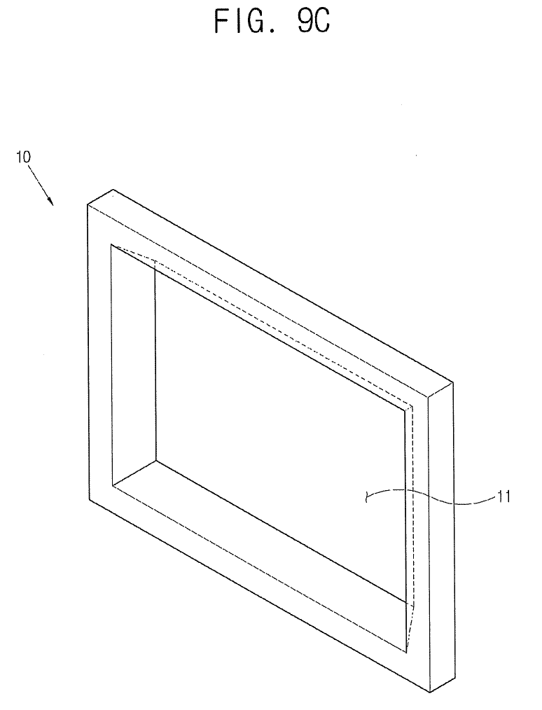

Next, the hole injection layer 221a is formed on the deposition-object substrate 2, as shown in FIGS. 9A and 9B.

The deposition-object substrate 2 is arranged with the pixel electrode 171 facing downward. The deposition-object substrate 2 is then rotated on a horizontal plane as shown in FIG. 9B. An open mask 10, which is arranged on the deposition-object substrate 2, defines a region in which the hole injection layer 221a is formed by blocking the deposition of the hole injection layer 221a on the portion of the deposition-object substrate 2 covered by the open mask 10. The open mask 10 rotates along with the deposition-object substrate 2.

In one exemplary embodiment the open mask 10 has a window frame-like shape with a rectangular opening 11 corresponding to a display region, as shown in FIG. 9C.

Referring to FIG. 9B, a hole injection material source 241, is located below the deposition-object substrate 2, and supplies a vapor to the deposition-object substrate 2. The vapor includes a hole injection material which then accumulates on the deposition-object substrate.

In the present exemplary embodiment the hole injection material source 241 is located biased towards the right side of the deposition-object substrate 2. Biasing the hole injection material source 241 towards the right side of the deposition-object substrate 2 ensures that it will receive an even coating of the hole injection material while rotating. In this state, hole injection material is uniformly deposited on the rotating deposition-object substrate 2.

As described above, by using the open mask 10, the hole injection layer 221a is formed inside the partition contact hole 211 as well as over the entire display region.

Although not shown, after the hole injection layer 221a is formed, the hole transfer layer 221b is deposited in a similar manner as the hole injection layer 221a to complete the formation of the lower common layer 221. The hole transfer layer 221b is also formed inside the partition contact hole 211.

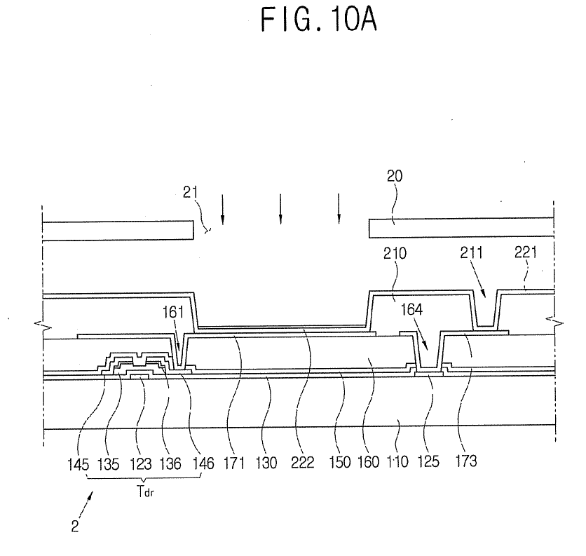

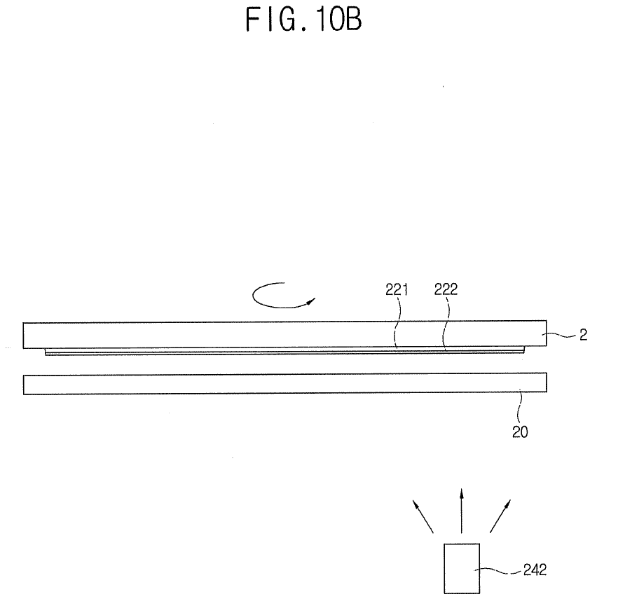

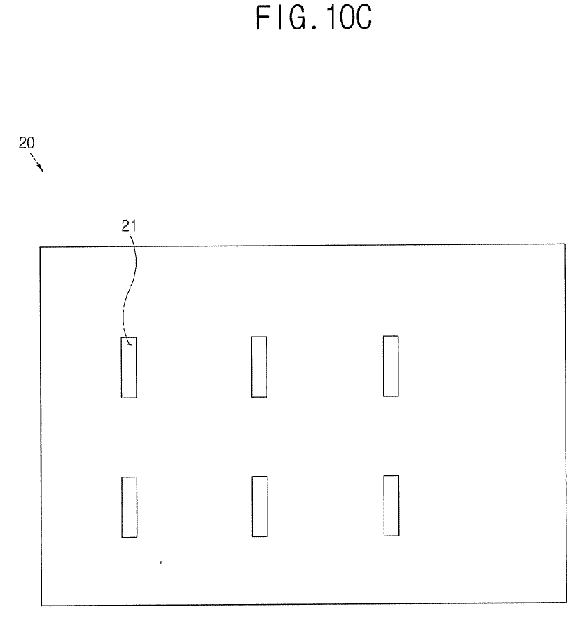

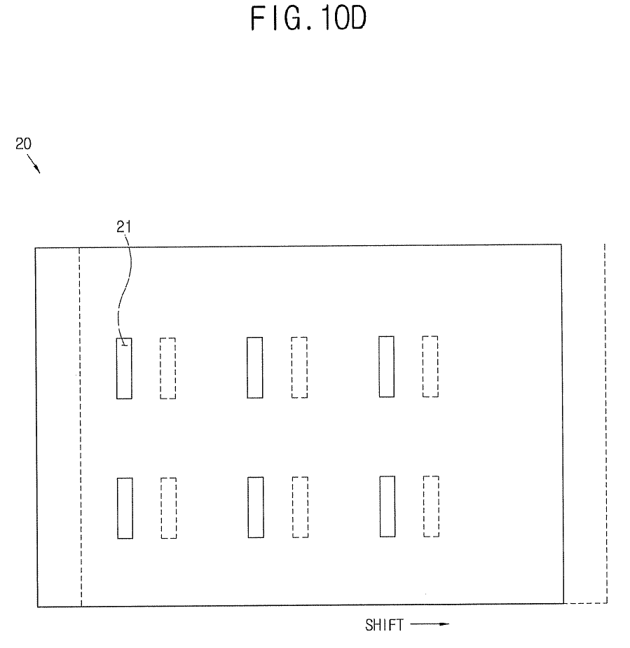

Next, the light emitting layer 222 is formed on the lower common layer 221, as shown in FIGS. 10A and 10B.

As shown in FIG. 10B, the deposition-object substrate 2 is arranged with the pixel electrode 171 directing downward, and rotates about itself on a horizontal plane, similar to the rotation described above with reference to the formation of the lower common layer 221. A shadow mask 20, which is arranged in the front of the deposition-object substrate 2, defines a region in which the light emitting layer 222 is formed. The shadow mask 20 rotates along with the deposition-object substrate 2.

The shadow mask 20 has openings 21 formed corresponding to a region in which the light emitting layer 222 as shown in FIG. 5 is formed, as shown in FIG. 10C.

Referring again to FIG. 10B, a light emitting material source 242, which is located below the deposition-object substrate 2, supplies a vapor to the deposition-object substrate 2. The vapor includes the light emitting material to be deposited on the deposition-object substrate 2.

In the exemplary embodiment wherein the display device includes a plurality of sub-pixels, each sub-pixel emitting a different colored light, the light emitting layer 222 is formed for each color while a relative position of the shadow mask 20 to the deposition-object substrate 2 is changed while the light emitting material source 242 is changed, as shown in FIG. 1D. The different colored light emitting layers 222 are formed at different locations on the deposition-object substrate 2 by depositing the different colored light emitting source material through the shifting positions of the shadow mask 20 as shown in FIG. 10D.

As described above, the light emitting layer 222 is formed through the openings 21 of the shadow mask 20, which are prearranged to correspond to the location of the pixel electrode 171. Accordingly, the light emitting layer 222 is formed discretely on the pixel electrode 171 and is not formed in the partition contact hole 211.

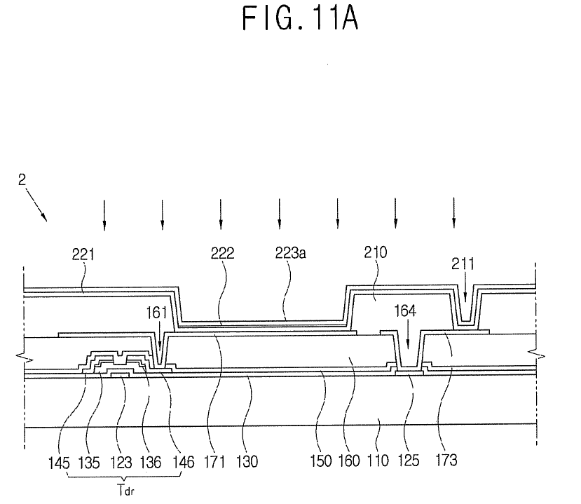

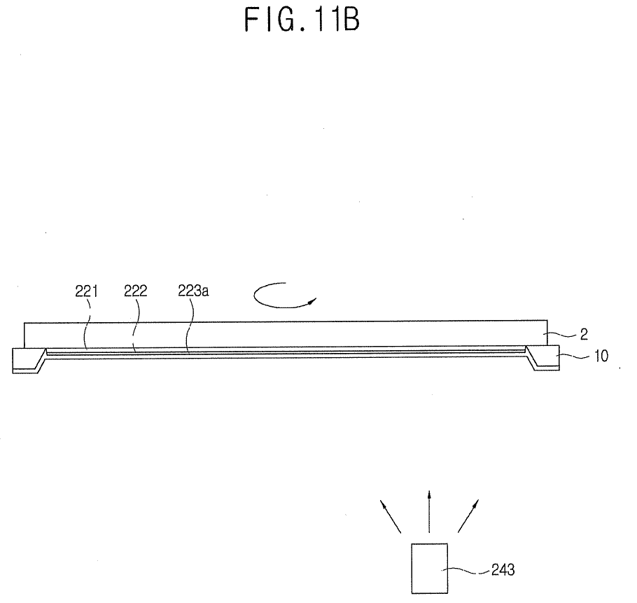

Next, the electron transfer layer 223a is formed on the light emitting layer 222, as shown in FIGS. 11A and 11B. A portion of the electron transfer layer 223a is formed on the lower common layer 221.

The deposition-object substrate 2 is arranged with the light emitting layer 222 directing downward, and rotates in about itself on a horizontal plane similar to that described above with respect to the formation of the lower common layer 221 and the light emitting layer 222. The open mask 10 used with the lower common layer 221 is arranged on the deposition-object substrate 2 to define a region in which the electron transfer layer 223a is formed. The open mask 10 rotates along with the deposition-object substrate 2.

An electron transfer material source 243, is located below the deposition-object substrate 2 to supply vapor to the deposition-object substrate 2. The vapor includes an electron transfer material to be deposited on the deposition-object substrate 2.

As described above, by using the open mask 10, the electron transfer layer 223a is formed inside the partition contact hole 211 as well as over the entire display region.

Although not shown, after the electron transfer layer 223a is formed, the electron injection layer 223b is deposited in a similar method as the deposition of the electron transfer layer 223a to complete the upper common layer 223. The electron transfer layer 223b is also formed inside the partition contact hole 211. Accordingly, both of the lower common layer 221 and the upper common layer 223 are formed inside the partition contact hole 211.

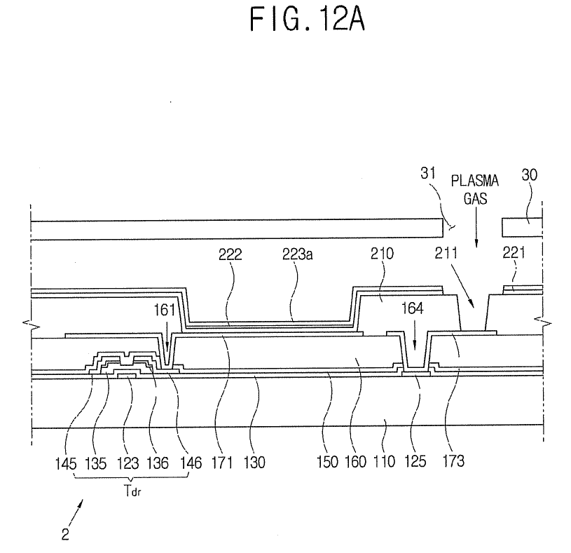

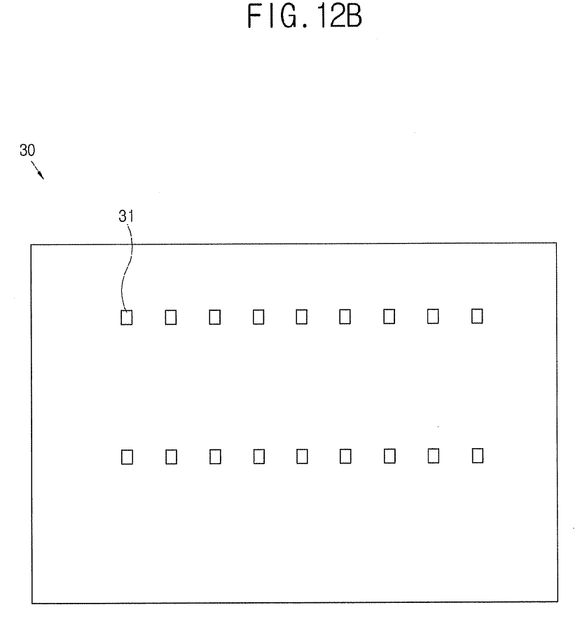

Next, the lower common layer 221 and the upper common layer 223, which are formed inside the partition contact hole 211, are ashed away, as shown in FIG. 12A.

The ashing process for the common layers 221 and 223 is performed using the shadow mask 30 and a plasma gas, exemplary embodiments of which include at least one of oxygen or argon plasma gasses.

As shown in FIG. 12B, the shadow mask 30 has openings 31 corresponding to the non-formation areas A shown in FIG. 4. The plasma gas removes the portions of the common layers 221 and 223 which are exposed through the openings 31.

The second bridge portion 173 is exposed on the partition contact hole 211 by the ashing process.

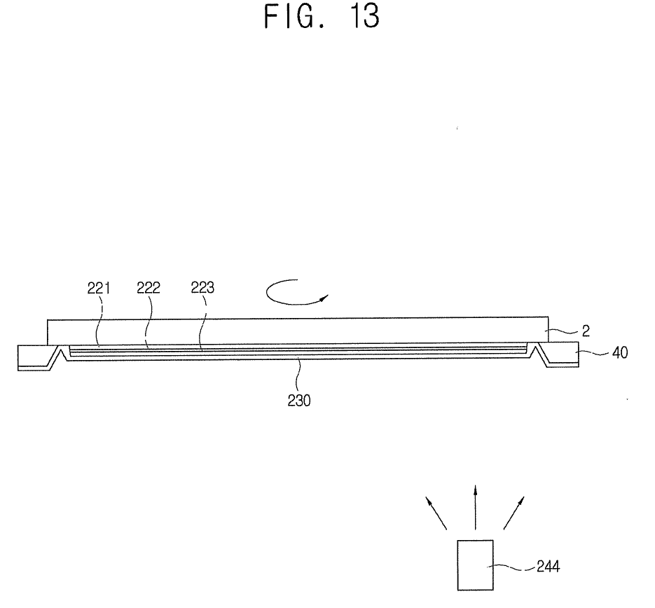

Next, the common electrode 230 is formed on the upper common layer 223, as shown in FIG. 13.

The deposition-object substrate 2 is arranged with the upper common layer 223 directed downward, and rotates about itself on a horizontal plane. An open mask 40 arranged on the deposition-object substrate 2 defines a region in which the common electrode 230 is formed. The open mask 40 rotates along with the deposition-object substrate 2.

A common electrode material source 244 is located below the deposition-object substrate 2 and supplies a vapor to the deposition-object substrate 2. The vapor includes a common electrode material.

The open mask 40 used to form the common electrode 230 has an opening which is larger than the opening 11 of the open mask 10 used to form the common layers 221 and 223. Accordingly, the common electrode 230 is formed somewhat larger than the display region, as shown in FIG. 4.

The common electrode 230 contacts the second bridge portion 173 exposed through the partition contact hole 211, which in turn is electrically connected with the auxiliary electrode line 125 through the contact hole 164. Accordingly, the common electrode 230 is supplied with a common voltage from the auxiliary electrode line 125. The common electrode 230 makes direct contact with the second bridge portion 173 due to the removal of the common layers 221 and 223 through the ashing process described above. Therefore the common electrode is easily supplied with a common voltage throughout its entire area, and the resistance across that area is significantly reduced.

In the above-described exemplary embodiment of a manufacturing method, each of the layers 221a, 221b, 223a and 223b constituting the common layers 221 and 223 is formed using the open mask 10. That is, an operation of moving the open mask 10 several times for each of the layers 221a, 221b, 223a and 223b in order to not form the common layers 221 and 223 inside the partition contact hole 211 is unnecessary. Accordingly, the common layers 221 and 223 may be formed through a highly simplified process.

The process of removing the common layers 221 and 223 from the partition contact hole 211 may be also simply performed since the common layers 221 and 223 are removed at the same time by using the shadow mask 30.

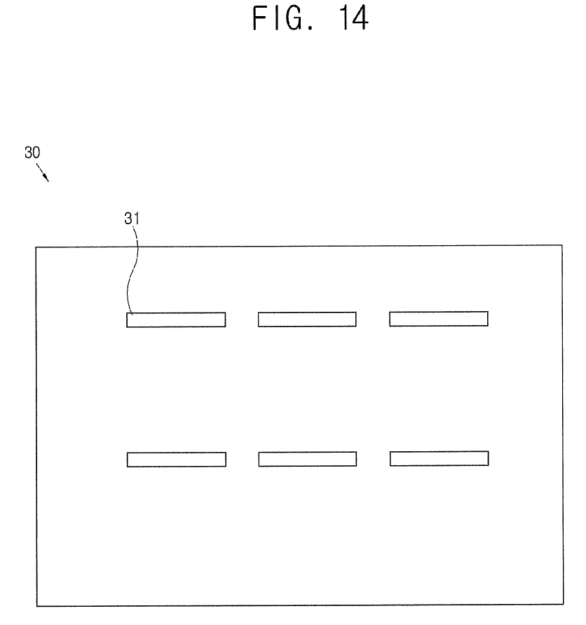

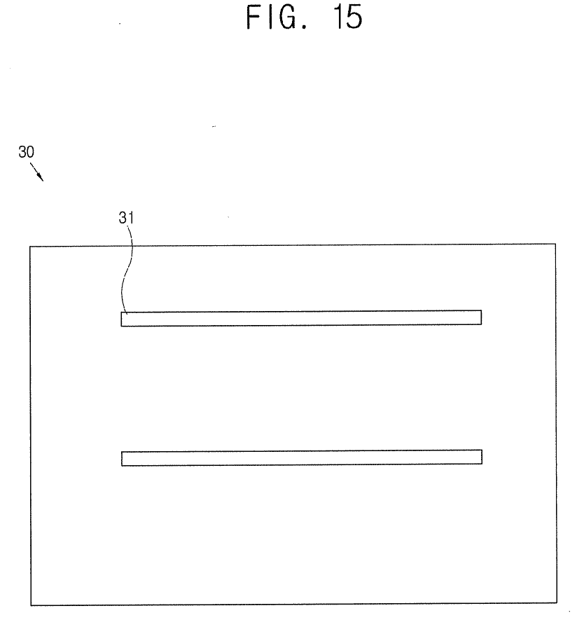

In the above-described exemplary embodiment, the shape of the openings 31 of the shadow mask 30 used for the ashing process may be modified in various forms. Exemplary embodiments including such modifications will be described with reference to FIGS. 14 and 15.

FIGS. 14 and 15 are top plan schematic views showing different forms of an exemplary embodiment of the shadow mask used for the ashing process in the exemplary embodiment of a method of manufacturing the first exemplary embodiment of a display apparatus according to the present invention.

Referring to FIG. 14, the opening 31 is formed corresponding to three adjacent non-formation areas A. Referring to FIG. 15, the opening 31 is formed corresponding to nine non-formation areas A.

In addition to the above described exemplary embodiments, the shape of the openings 31 may be modified in various forms depending on arrangement of the partition contact hole 211, a margin of error in the alignment of the deposition-object substrate 2 with the shadow mask 30, a distance between the partition contact hole 211 and the light emitting layer 222, and various other factors. The shape of the non-formation areas A is varied depending on the shape of the openings 31.

The above-described first exemplary embodiment of a display apparatus employs low molecular weight material as the organic layers. However, in alternative exemplary embodiments the organic layers may be high molecular weight material, explanation of which will be described below with reference to second and third exemplary embodiments of the present invention.

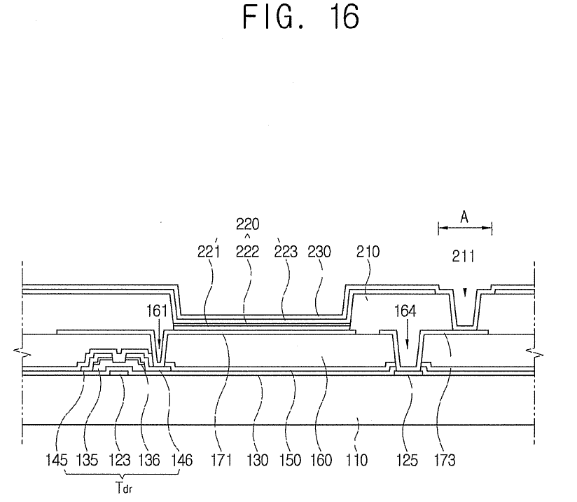

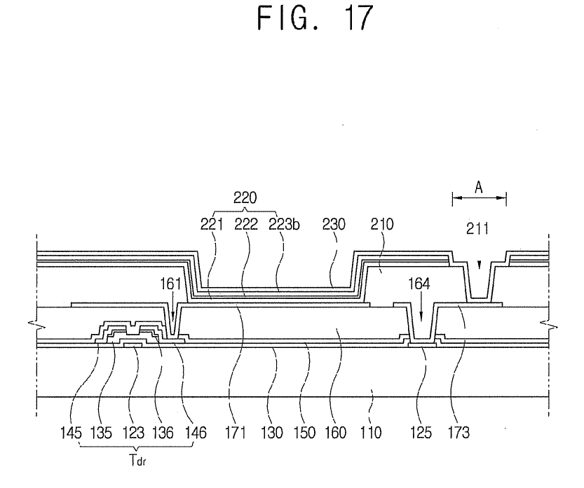

FIGS. 16 and 17 are cross-sectional views of display apparatuses according to second and third exemplary embodiments of the present invention, respectively.

In the second exemplary embodiment shown in FIG. 16, a light emitting device layer 220 includes a hole injection layer 221a, a light emitting layer 222 and an electron injection layer 223b. The hole injection layer 221a and the light emitting layer 222 are made of a high molecular weight material and are formed on the pixel electrode 171.

In one exemplary embodiment, the hole injection layer 221a may be made of a mixture of polythiophene derivatives, exemplary embodiments of which include poly(3,4-ethylendioxythiophene) (“PEDOT”), and polystyrene sulfonic acid (“PSS”). In one exemplary embodiment the hole injection layer 221a may be formed by an inkjet method. Unlike the exemplary embodiment shown in FIG. 3, the lower common layer 221 does not extend beyond the partition 210.

In one exemplary embodiment the light emitting layer 222 may be formed by doping perylene coloring matter, rhodamine coloring matter, rubrene, perylene, 9,10-diphenylanthracene, tetraphenylbutadiene, Nile Red, Coumarin 6, Quinacridone, and other similar materials into polyfluorene derivatives, (poly)paraphenylenevinylene derivatives, polyphenylene derivatives, polyvinylcarbazole, polythiophene derivatives, or high molecular weight materials made therefrom. In one exemplary embodiment the light emitting layer 222 may also be formed by an inkjet method.

In one exemplary embodiment the electron injection layer 223b may be made of lithium fluoride (“LiF”) and is formed using the open mask 10, as shown in FIG. 11b. Accordingly, the electron injection layer 223b is formed in succession over the entire display region, excluding the area around the partition contact hole 211.

In the third exemplary embodiment shown in FIG. 17, a light emitting device layer 220 includes a hole injection layer 221a, a light emitting layer 222 and an electron injection layer 223b. Of these, the hole injection layer 221a and the light emitting layer 222 are made of high molecular weight material. Unlike the first exemplary embodiment, the light emitting layer 222 extends to cover substantially the same region as covered by the hole injection layer 221a, but the light emitting layer 222 is removed around the partition contact hole 211.

In the third exemplary embodiment, the hole injection layer 221a and the light emitting layer 222 are formed in the same region using a nozzle coater and are removed through an ashing process similar to that described above with reference to the first exemplary embodiment.

As apparent from the above description, the present invention provides a display apparatus with an auxiliary electrode line and a common electrode connected thereto which has a simple manufacturing process.

In addition, the present invention provides a simple method of manufacturing a display apparatus with an auxiliary electrode line and a common electrode connected thereto.

Although a few exemplary embodiments of the present invention have been shown and described, it will be appreciated by those skilled in the art that changes may be made in these exemplary embodiments without departing from the principles and spirit of the present invention, the scope of which is defined in the appended claims and their equivalents.

What is claimed is:

1. A display apparatus comprising:
an insulating substrate;
a first signal line formed on the insulating substrate;
a second signal line crossing the first signal line;
an auxiliary electrode line which is supplied with a common voltage disposed on the insulating substrate;
a first plurality of thin film transistors formed on the insulating substrate electrically connected with the first signal line and the second signal line;
a second plurality of thin film transistors electrically connected with the first plurality of thin film transistors;
pixel electrodes connected to one of the plural thin film transistors, each pixel electrode comprising a reflective layer;
a conductive bridge portion connected to the auxiliary electrode line through a first contact hole;
partitions including second contact holes which expose the bridge and surround the pixel electrodes;
a light emitting device layer comprising a light emitting layer formed in a first region on the pixel electrodes, and a common layer exposing the first and the second contact holes formed on the first region and a second region surrounding the first region; and
a common electrode formed on the light emitting device layer and electrically connected to the bridge through the second contact holes.

2. The display apparatus according to claim 1, wherein the common layer is formed in substantially one part throughout the display device.

3. The display apparatus according to claim 1, wherein the light emitting layer is made of a high molecular weight material, and
the common layer comprises an electron injection layer formed on the light emitting layer.

4. The display apparatus according to claim 1, wherein the light emitting layer is made of a low molecular weight material, and
the common layer comprises a first sub-common layer disposed below the light emitting layer and a second sub-common layer disposed above the light emitting layer.

5. The display apparatus according to claim 1, wherein the pixel electrodes and the conductive bridge portion are disposed substantially the same distance from the insulating substrate.

6. A display apparatus having a display region and a non-display region, comprising:
an insulating substrate;
a first signal line formed on the insulating substrate;
a second signal line which crosses the first signal line;
an auxiliary electrode line which is supplied with a common voltage disposed on the insulating substrate;
a first plurality of thin film transistors formed on the insulating substrate electrically connected with the first signal line and the second signal line;
a second plurality of thin film transistors electrically connected to the first plurality of thin film transistors;
pixel electrodes connected to one of the first plurality of thin film transistors;
partitions which include contact holes and surround the pixel electrodes;
a light emitting device layer formed in substantially one piece on the pixel electrodes and the partitions in the display region, including non-formation holes corresponding to the contact holes; and
a common electrode formed on the light emitting device layer and connected to the auxiliary electrode line through the non-formation and contact holes.

7. The display apparatus according to claim 6, wherein the light emitting device layer comprises:
a light emitting layer formed in a first region corresponding to the pixel electrodes; and
a common layer formed on the first region and a second region surrounding the first region.

8. The display apparatus according to claim 6, wherein the contact holes are formed in a region separated from the first region.

9. The display apparatus according to claim 6, wherein each of the pixel electrodes comprises a reflective layer and the common electrode is substantially transparent.

10. A method of manufacturing a display apparatus, comprising:
forming a first plurality of thin film transistors electrically connected with a first signal line and a second signal line on an insulating substrate;
forming an auxiliary electrode line on the insulating substrate;
forming a bridge portion which contacts the auxiliary electrode line;
connecting pixel electrodes to one of the plurality of thin film transistors through first contact holes;
forming partitions surrounding the pixel electrodes and including second contact holes which expose the bridge portion;
forming a light emitting device layer comprising a light emitting layer and a common layer on the pixel electrodes and the partitions;
removing the light emitting device layer from the second contact holes; and
forming a common electrode on the light emitting device wherein the common electrode is connected to the bridge through the second contact holes.

11. The method according to claim 10, wherein the removing the light emitting device layer comprises using a first shadow mask having openings formed corresponding to the second contact holes.

12. The method according to claim 11, wherein the removing the light emitting device layer comprises using at least one of oxygen and argon produced from a plasma gas.

13. The method according to claim 10, wherein the common layer is formed using an open mask.

14. The method according to claim 13, wherein the common layer is removed when the light emitting device layer is removed, and
the common layer comprises at least one of a hole injection layer, a hole transfer layer, an electron transfer layer, and an electron injection layer.

15. The method according to claim 10, wherein each of the pixel electrodes comprises a reflective layer.

16. A method of manufacturing a display apparatus, comprising:
forming an auxiliary electrode line applied with a common voltage on an insulating substrate;
forming partitions which include contact holes which facilitate an electrical connection between the auxiliary electrode line and a common electrode;
forming a light emitting device layer on the partitions;
removing the light emitting device layer formed on the contact holes; and
forming the common electrode on the light emitting device layer, wherein the common electrode is connected to the auxiliary electrode line through the contact holes.

17. The method according to claim 16, wherein the removing the light emitting device layer comprises using a shadow mask having openings formed corresponding to the contact holes.
